(19) United States
(12) Patent Application Publication
(10) Pub. No.: US 2020/0156642 A1
(43) Pub. Date: May 21, 2020

(54) VEHICLE CONTROL APPARATUS

(71) Applicant: TOYOTA JIDOSHA KABUSHIKI KAISHA, Toyota-shi (JP)

(72) Inventors: Kohei TOCHIGI, Susono-shi (JP); Shogo ITO, Sunto-gun (JP); Yuta IKEZAWA, Susono-shi (JP); Hirotada OTAKE, Sunto-gun (JP)

(73) Assignee: TOYOTA JIDOSHA KABUSHIKI KAISHA, Toyota-shi (JP)

(21) Appl. No.: 16/686,927

(22) Filed: Nov. 18, 2019

(30) Foreign Application Priority Data
Nov. 20, 2018 (JP) 2018-217472

(51) Int. Cl. B60W 30/18; B60W 10/04

(52) U.S. Cl. CPC B60W 30/18109; B60W 10/04; B60W 2550/308; B60W 2550/10; B60W 2720/106; B60W 2540/10

(57) ABSTRACT

A vehicle control apparatus is provided with: a specifier configured to specify an object toward which a host vehicle goes; an arithmetic operator configured to arithmetically operate an erroneous stepping risk on the basis of a type of the object; and a suppressor configured to perform a suppression control of suppressing a driving force of the host vehicle when an operation amount condition determined in accordance with the erroneous stepping risk is satisfied. An upper limit of the erroneous stepping risk for an object which do not collide with the host vehicle is set small in comparison with an upper limit of the erroneous stepping risk for an object which may collide with the host vehicle. The suppressor moderates an extent of suppression of the driving force in the suppression control when the erroneous stepping risk is low, in comparison with when the erroneous stepping risk is high.

### CROSS-REFERENCE TO RELATED APPLICATIONS

This application is based upon and claims the benefit of priority of the prior Japanese Patent Application No. 2018-217472, filed on Nov. 20, 2018, the entire contents of which are incorporated herein by reference.

### BACKGROUND

### 1. Technical Field

Embodiments of the present disclosure relate to a vehicle control apparatus.

### 2. Description of the Related Art

For this type of apparatus, for example, there is proposed an apparatus configured to limit a driving force of a host vehicle to a driving force limit value in accordance with a steering operation amount, if a relative distance between the host vehicle and an obstacle is less than or equal to a relative distance for limitation, and if a driving force operation amount, which is an operation amount of an accelerator pedal, exceeds a driving force operation amount threshold value (refer to International Publication No. WO14/083763 (Patent Literature 1)). There is also proposed an apparatus (i) configured to calculate a total certainty factor on the basis of a parking frame certainty factor and a parking frame entry certainty factor, wherein the total certainty factor indicates an overall degree of certainty of the parking frame certainty factor and the parking frame entry certainty factor, wherein the parking frame certainty factor indicates a degree of certainty of the presence of a parking frame in a direction of travel of the host vehicle, and wherein the parking frame entry certainty factor indicates a degree of certainty of entry of the host vehicle into the parking frame, (ii) configured to suppress acceleration of the host vehicle, which is controlled in accordance with the operation amount of the accelerator pedal, at a low suppression degree when the total certainty factor is low, in comparison with when the total certainty factor is high, and (iii) configured to suppress the acceleration of the host vehicle at a lower suppression degree with increasing speed of the host vehicle (refer to International Publication No. WO14/083824 (Patent Literature 2)).

Meanwhile, it is known that a driver erroneously steps on the accelerator pedal instead of a brake pedal, which is referred to as erroneous stepping on the accelerator. The technologies/techniques disclosed in the Patent Literatures 1 and 2 can be used against the erroneous stepping on the accelerator pedal. On the other hand, when the erroneous stepping on the accelerator pedal occurs, if the driving force or the degree of suppression of the acceleration of the host vehicle is the same for an object that has a possibility of collision with the host vehicle, such as the obstacle described in the Patent Literature 1, and for an object that has no possibility of collision with the host vehicle, such as the parking frame described in the Patent Literature 2, then, the driver may feel uncomfortable, which is technically problematic.

### SUMMARY

In view of the aforementioned problem, it is therefore an object of embodiments of the present disclosure to provide a vehicle control apparatus that can appropriately deal with the erroneous stepping on the accelerator pedal while preventing the driver from feeling uncomfortable.

The above object of embodiments of the present disclosure can be achieved by a vehicle control apparatus provided with: a specifier configured to specify an object toward which a host vehicle goes; an arithmetic operator configured to arithmetically operate an erroneous stepping risk on the basis of a type of the specified object, wherein the erroneous stepping risk indicates an extent of a risk caused by erroneous stepping on an accelerator pedal in which a driver of the host vehicle erroneously steps the accelerator pedal instead of a brake pedal; and a suppressor configured to perform a suppression control of suppressing a driving force of the host vehicle when an operation amount condition associated with an operation amount of the accelerator pedal is satisfied, wherein the operation amount condition is determined in accordance with the erroneous stepping risk, wherein an upper limit of the erroneous stepping risk when the type of the specified object is a type indicating no collision with the host vehicle is set small in comparison with an upper limit of the erroneous stepping risk when the type of the specified object is a type indicating a possibility of collision with the host vehicle, and the suppressor is configured to moderate an extent of suppression of the driving force in the suppression control when the erroneous stepping risk is low, in comparison with when the erroneous stepping risk is high.

### BRIEF DESCRIPTION OF THE DRAWINGS

FIG. 1 is a block diagram illustrating a configuration of a vehicle control apparatus according to an embodiment;

FIG. 2A is a diagram illustrating a concept of an enterable space according to the embodiment;

FIG. 2B is a diagram illustrating a concept of the enterable space according to the embodiment;

FIG. 3 is a diagram illustrating an example of a map for defining a method of limiting a driving force; and

FIG. 4 is a flowchart illustrating operations of the vehicle control apparatus according to the embodiment.

### DETAILED DESCRIPTION OF THE EMBODIMENT

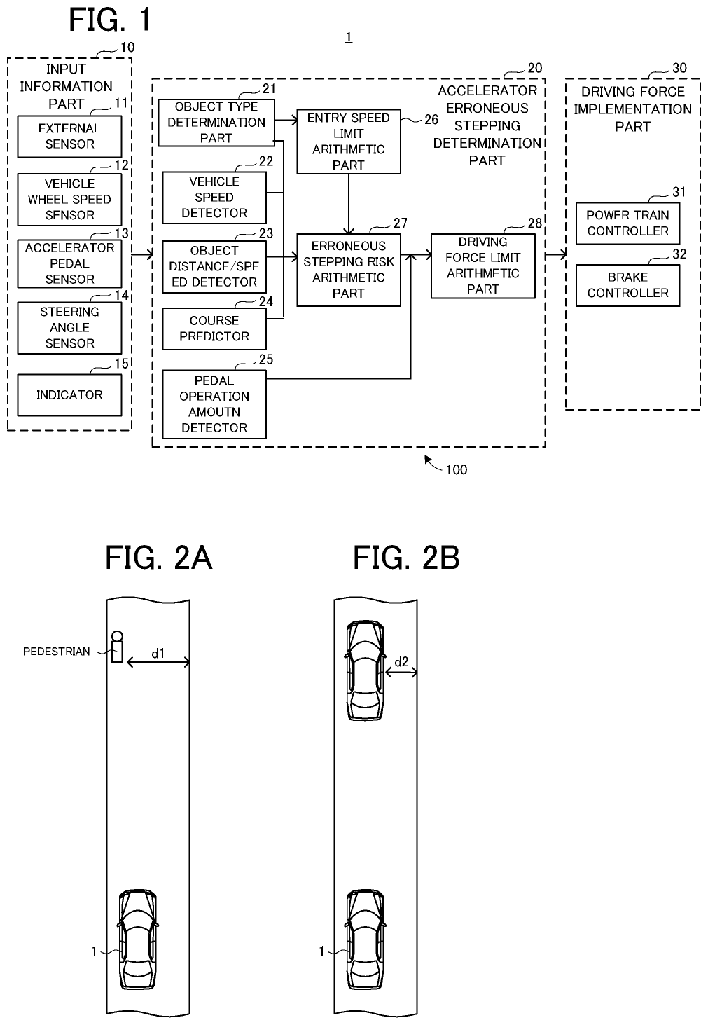

A vehicle control apparatus according to an embodiment of the present disclosure will be explained with reference to FIG. 1 to FIG. 4.

(Configuration)

A configuration of the vehicle control apparatus according to the embodiment will be explained with reference to FIG. 1. FIG. 1 is a block diagram illustrating a configuration of the vehicle control apparatus according to the embodiment.

A vehicle control apparatus 100 is mounted on a vehicle 1. The vehicle control apparatus 100 is provided with an input information part 10, an accelerator erroneous stepping determination part 20, and a driving force implementation part 30.

The input information part 10 is provided with an external sensor 11, a vehicle wheel speed sensor 12, an accelerator pedal sensor 13, a steering angle sensor 14, and an indicator 15. The external sensor 11 is provided, for example, with a millimeter wave radar, a camera, and the like. A detailed explanation of the vehicle wheel speed sensor 12, the accelerator pedal sensor 13, the steering angle sensor 14, and the indicator 15 will be omitted because the existing technologies/techniques can be applied thereto.

The driving force implementation part 30 is provided with a power train controller 31 and a brake controller 32. A detailed explanation of the power train controller 31 and the brake controller 32 will be omitted because the existing technologies/techniques can be applied thereto.

The accelerator erroneous stepping determination part 20 is configured to arithmetically operate an erroneous stepping risk, which indicates an extent of a risk caused by erroneous stepping on an accelerator pedal in which a driver of the vehicle 1 erroneously steps the accelerator pedal instead of a brake pedal. The accelerator erroneous stepping determination part 20 is provided with an object type determination part 21, a vehicle speed detector 22, an object distance/speed detector 23, a course predictor 24, a pedal operation amount detector 25, an entry speed limit arithmetic part 26, an erroneous stepping risk arithmetic part 27, and a driving force limit arithmetic part 28.

The object type determination part 21 is configured to determine a type of an object that can be a target of the accelerator erroneous stepping determination part 20, on the basis of an output of the external sensor 11 (e.g., a detection result from the millimeter wave radar, an image photographed by the camera, etc.). Here, the object that can be the target of the accelerator erroneous stepping determination part 20 includes an object that has a possibility of collision with the vehicle 1, such as, for example, a vehicle, a pedestrian, a bicycle, and a structure, and an object that has no possibility of collision with the vehicle 1, such as, for example, a red light, a stop sign, a curve, and an intersection. If a plurality of objects are detected on the basis of the output of the external sensor 11, the object type determination part 21 may determine respective types of the plurality of objects.

Various existing aspects can be applied to a method of determining the type of the object, but the object type determination part 21 may determine at least any of (i) an object that has a possibility of collision with the vehicle 1, (ii) an object that requires a stop of the vehicle 1 from among objects that do not collide with the vehicle 1, and (iii) an object that does not require the stop of the vehicle 1 from among the objects that do not collide with the vehicle 1.

The vehicle speed detector 22 is configured to detect a vehicle speed of the vehicle 1 on the basis of an output of the vehicle wheel speed sensor 12. The object distance/speed detector 23 is configured to detect a distance from the vehicle 1 to the object and a relative speed between the vehicle 1 and the object, on the basis of the output of the external sensor 11. Here, if the object is a red light or a stop sign, a distance from the vehicle 1 to a stop line corresponding to the red light or the stop sign may be set as the distance from the vehicle 1 to the object. Moreover, if the object is a curve or an intersection, a distance from the vehicle 1 to an entrance of the curve or the intersection may be set as the distance from the vehicle 1 to the object.

The course predictor is configured to predict a course of the vehicle 1, for example, on the basis of an output of the steering angle sensor 14, a state of the indicator 15, or the like. A detailed of a method of predicting the course of the vehicle 1 will be omitted because various existing aspects can be applied thereto. The pedal operation amount detector 25 is configured to detect an operation amount of the accelerator pedal on the basis of an output of the accelerator pedal sensor 13. Here, the operation amount of the accelerator pedal is a parameter obtained on the basis of a stepping speed of the accelerator pedal and a stepping amount of the accelerator pedal.

The entry speed limit arithmetic part 26 is configured to arithmetically operate an upper limit value of the speed of the vehicle 1 in a position of the object (hereinafter referred to as an “entry speed limit” as occasion demands) on the basis of a determination result by the object type determination part 21. Here, if the object is an object that has a possibility of collision with the vehicle 1, the upper limit value is “0 km/h”. If the object is a curve, the upper limit value is arithmetically operated, for example, from a curve radius of the curve and the magnitude of lateral acceleration, which is generated in the vehicle 1 when it passes the curve. If the object is a red light or a stop sign, the upper limit value is typically “0 km/h”. In actuality, however, the vehicle 1 may overrun the stop line corresponding to the red light or the stop sign before stopping. Thus, if the object is a red light or a stop sign, the upper limit value may be set to a speed that is greater than “0 km/h” (e.g., “10 km/h”, etc.).

The erroneous stepping risk arithmetic part 27 is configured to arithmetically operate the erroneous stepping risk, on the basis of respective outputs of the object type determination part 21, the vehicle speed detector 22, the object distance/speed detector 23, the course predictor 24, and the entry speed limit arithmetic part 26.

Specifically, the erroneous stepping risk arithmetic part 27 may first specify an object toward which the vehicle 1 goes, on the basis of the curse of the vehicle 1 predicted by the course predictor 24. Now, specific examples of the “object toward which the vehicle 1 goes” will be explained. If the predicted course of the vehicle 1 is going straight and if another vehicle travels ahead of the vehicle 1, the “object toward which the vehicle 1 goes” is the other vehicle. If the predicted course of the vehicle 1 near an intersection is entering a right-turn lane and if an arrow signal light indicating that a right turn is allowed is on, the “object toward which the vehicle 1 goes” is the intersection. On the other hand, if the predicted course of the vehicle 1 near an intersection is entering a straight through lane and if a traffic light corresponding to the straight through lane is red, the “object toward which the vehicle 1 goes” is the red light. If the predicted course of the vehicle 1 is changing a traffic lane to an adjacent lane in a situation in which another vehicle travels ahead of the vehicle 1 on the traffic lane on which the vehicle 1 currently travels in a straight-line section and in which there is no vehicle on the lane adjacent to the traffic lane, then, the “object toward which the vehicle 1 goes” is “none”, i.e., there is no object.

The erroneous stepping risk arithmetic part 27 may then specify the type of the specified object on the basis of a determination result by the object type determination part 21. If the type of the object specified is an object that has a possibility of collision with the vehicle 1, the erroneous stepping risk arithmetic part 27 may set a maximum erroneous stepping risk to be “high”. On the other hand, if the type of the object specified is an object that does not collide with the vehicle 1, the erroneous stepping risk arithmetic part 27 may set the maximum erroneous stepping risk to be “middle” when the vehicle speed detected by the vehicle speed detector 22 is greater than or equal to the entry speed limit arithmetically operated by the entry speed limit arithmetic part 26, and the erroneous stepping risk arithmetic part 27 may set the maximum erroneous stepping risk to be “low” when the vehicle speed is less than the entry speed limit.

In parallel with setting the maximum erroneous stepping risk, the erroneous stepping risk arithmetic part 27 may arithmetically operate a provisional erroneous stepping risk, on the basis of the type of the object determined by the object type determination part 21, the vehicle speed detected by the vehicle speed detector 22, the distance and relative speed between the vehicle 1 and the object detected by the object distance/speed detector 23, the course of the vehicle 1 predicted by the course predictor 24, the presence/absence of an enterable space, and the like.

Now, the enterable space will be explained with reference to FIG. 2A and FIG. 2B. The enterable space means a space in which a distance in a width direction of a road is greater than a vehicle width of the vehicle 1 (e.g., a length in the width direction of the road) and that extends in a direction of extension of the road. If the object is an object that has a possibility of collision with the vehicle 1, a part of the road (or traffic lane) is occupied by the object. In this case, if a distance from the object to one end of the road (or traffic lane) is greater than the vehicle width of the vehicle 1, there shall be an enterable space.

Specifically, in FIG. 2A, when a distance d1 from a pedestrian as the object to one end of the road is greater than the vehicle width of the vehicle 1, there is an enterable space, and when the distance d1 is less than the vehicle width of the vehicle 1, there is no enterable space. In the same manner, in FIG. 2B, when a distance d2 from another vehicle as the object to one end of the road is greater than the vehicle width of the vehicle 1, there is an enterable space, and when the distance d2 is less than the vehicle width of the vehicle 1, there is no enterable space. If the object is an object that does not collide with the vehicle 1, a road width (or lane width) is greater than the vehicle width of the vehicle 1, so that there is an enterable space.

An example of a method of arithmetically operate the provisional erroneous stepping risk will be explained. Here, a score is set to “3” when the type of the object is an object that has a possibility of collision with the vehicle 1, and the score is set to “1” when the type is an object that does not collide with the vehicle 1. The score is set to be “3” when the vehicle speed of the vehicle 1 is relatively high, and the score is set to be “1” when the vehicle speed is relatively low. The score is set to be “3” when the distance from the vehicle 1 to the object is relatively close, and the score is set to be “1” when the distance is relatively far. The score is set to be “3” when a time required for the vehicle 1 to pass the object, which is obtained on the basis of the distance and relative speed between the vehicle 1 and the object, is relatively short, and the score is set to be “1” when the time is relatively long. The score is set to be “3” when there is no enterable space, or when there is an enterable space, but the predicted course of the vehicle 1 is not toward an enterable space. The score is set to be “1” when there is an enterable space and the predicted course of the vehicle 1 is approaching the enterable space. The score is set to be “3” when a current vehicle speed of the vehicle 1 is greater than or equal to the entry speed limit, and the score is set to be “1” when the current vehicle speed is less than the entry speed limit.

The erroneous stepping risk arithmetic part 27 may set the provisional erroneous stepping risk to be “high” when a total score obtained by summing up the aforementioned scores is relatively large, may set the provisional erroneous stepping risk to be “low” when the total score is relatively small, and may set the provisional erroneous stepping risk to be “middle” when the total score is to an intermediate degree. Then, the erroneous stepping risk arithmetic part 27 may set the provisional erroneous stepping risk to the erroneous stepping risk when the provisional erroneous stepping risk is less than or equal to the maximum erroneous stepping risk. On the other hand, the erroneous stepping risk arithmetic part 27 may set the maximum erroneous stepping risk to the erroneous stepping risk when the provisional erroneous stepping risk is greater than the maximum erroneous stepping risk.

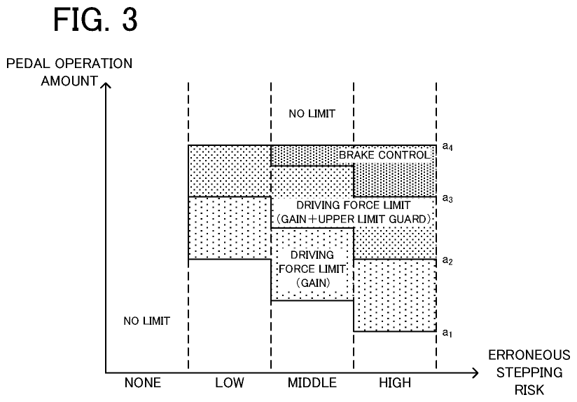

The driving force limit arithmetic part 28 is configured to determine whether or not the driving force is to be limited and a limit method when the driving force is limited, on the basis of the erroneous stepping risk arithmetically operated by the erroneous stepping risk arithmetic part 27, a pedal operation amount (i.e., the operation amount of the accelerator pedal) detected by the pedal operation amount detector 25, and, for example, a map illustrated in FIG. 3.

Specifically, the driving force limit arithmetic part 28 may determine an operation amount condition associated with the pedal operation amount, on the basis of the erroneous stepping risk arithmetically operated by the erroneous stepping risk arithmetic part 27 and, for example, the map illustrated in FIG. 3. The operation amount condition is a condition for determining whether or not the driver has erroneously stepped on the accelerator pedal instead of the brake pedal. The driving force limit arithmetic part 28 may determine that the driver has erroneously stepped on the accelerator pedal instead of the brake pedal when the pedal operation amount detected by the pedal operation amount detector 25 satisfies requirements defined by the operation amount condition, i.e., when the operation amount condition is satisfied. As a result, the driving force limit arithmetic part 28 may determine that the driving force is to be limited. In this case, the driving force limit arithmetic part 28 may further determine the limit method on the basis of the pedal operation amount detected by the pedal operation amount detector 25 and the map illustrated in FIG. 3.

For example, when the erroneous stepping risk is “high”, if the pedal operation amount detected by the pedal operation amount detector 25 is within a range of a pedal operation amount a₁ to a pedal operation amount a₄ on the map illustrated in FIG. 3, the driving force limit arithmetic part 28 may determine that the driver has erroneously stepped on the accelerator pedal instead of the brake pedal. In this case, the operation amount condition is “a₁<pedal operation amount<a₄”. Then, the driving force limit arithmetic part 28 may determine that the driving force is to be limited.

When it is determined that the driving force is to be limited, the driving force limit arithmetic part 28 may determine the limit method, for example, in accordance with which of the following ranges on the map illustrated in FIG. 3 the pedal operation amount detected by the pedal operation amount detector 25 corresponds to; namely, (i) a range of the pedal operation amount a₁ to a pedal operation amount a₂, (ii) a range of the pedal operation amount a₂ to a pedal operation amount a₃, and (iii) a range of the pedal operation amount a₃ to a pedal operation amount a₄.

As is clear from FIG. 3, when the erroneous stepping risk is low, a hatching part is smaller than when the erroneous stepping risk is high. It is thus hardly determined that the driver has erroneously stepped on the accelerator pedal instead of the brake pedal. In other words, when the erroneous stepping risk is low, the operation amount condition is hardly satisfied in comparison with when the erroneous stepping risk is high.

The driving force limit arithmetic part 28 may arithmetically operate a target value of the driving force or a braking force, on the basis of a determination result of whether or not the driving force is to be limited and the limit method when the driving force is to be limited. The arithmetically operated target value may be outputted to the power train controller 31 and the brake controller 32.

In FIG. 3, “DRIVING FORCE LIMIT (GAIN)” means to set a gain associated with an accelerator pedal operation to be smaller than a normal gain. In FIG. 3, “DRIVING FORCE LIMIT (GAIN+UPPER LIMIT GUARD)” means to set the gain associated with the accelerator pedal operation to be smaller than the normal gain, and moreover, to set an upper limit for the driving force outputted in accordance with the stepping amount of the accelerator pedal (i.e., to prevent the driving force from increasing over the upper limit). “BRAKE CONTROL” means to brake the vehicle 1 (i.e., typically, to decelerate the vehicle 1). The reason for “NO LIMIT” when the pedal operation amount is extremely high in the erroneous stepping risk (i.e., “high”, “middle”, “low”) in FIG. 3 is that the driver intentionally strongly steps the accelerator pedal, relatively highly likely.

The limit of the driving force is stronger in the order of “DRIVING FORCE LIMIT (GAIN)”, “DRIVING FORCE LIMIT (GAIN+UPPER LIMIT GUARD)”, and “BRAKE CONTROL”. In other words, “DRIVING FORCE LIMIT (GAIN+UPPER LIMIT GUARD)” has a higher effect of suppressing the driving force of the vehicle 1 than that of “DRIVING FORCE LIMIT (GAIN)”, and “BRAKE CONTROL” has a higher effect of suppressing the driving force of the vehicle 1 than that of “DRIVING FORCE LIMIT (GAIN+UPPER LIMIT GUARD)”. Here, with reference to FIG. 3, when the erroneous stepping risk is low, it can be said that the extent of suppression of the driving force when the driving force is limited is moderated in comparison with when the erroneous stepping risk is high.

(Operation)

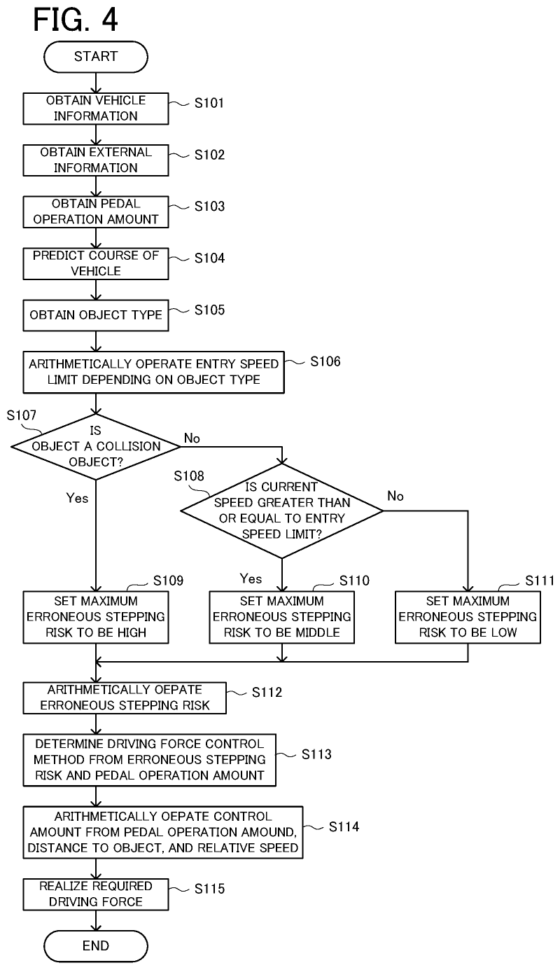

Operations of the vehicle control apparatus 100 as configured above will b explained with reference to a flowchart in FIG. 4.

In FIG. 4, the accelerator erroneous stepping determination part 20 obtains vehicle information associated with the vehicle 1 from the respective outputs of the vehicle wheel speed sensor 12, the accelerator pedal sensor 13, and the steering angle sensor 14, and from the state of the indicator 15 (step S101). In parallel with the step S101, the accelerator erroneous stepping determination part 20 obtains external information from the output of the external sensor 11 (step S102).

After the step S101, the pedal operation amount detector 25 detects the operation amount of the accelerator pedal on the basis of the output of the accelerator pedal sensor 13 (step S103). In parallel with the step S103, the course predictor 24 predicts the course of the vehicle 1, for example, on the basis of the output of the steering angle sensor 14, the state of the indicator 15, or the like (step S104).

The erroneous stepping risk arithmetic part 27 specifies the object toward which the vehicle 1 goes, on the basis of the predicted course of the vehicle 1. Then, the erroneous stepping risk arithmetic part 27 obtains the type of the specified object from the object type determination part 21 (step S105). At this time, the entry speed limit arithmetic part 26 arithmetically operates the entry speed limit, on the basis of the type of the specified object, which is determined by the object type determination part 21 (step S106).

The erroneous stepping risk arithmetic part 27 then determines whether or not the object is an object that has a possibility of collision with the vehicle 1 (step S107). In the step S107, if it is determined that the object is an object that has a possibility of collision with the vehicle 1 (the step S107: Yes), the erroneous stepping risk arithmetic part 27 sets the maximum erroneous stepping risk to be “high” (step S109).

In the step S107, if it is determined that the object is an object that has no possibility of collision with the vehicle 1 (the step S107: No), the erroneous stepping risk arithmetic part 27 determines whether or not the vehicle speed detected by the vehicle speed detector 22 is greater than or equal to the entry speed limit arithmetically operated by the entry speed limit arithmetic part 26 (step S108).

In the step S108, if it is determined that the vehicle speed is greater than or equal to the entry speed limit (the step S108: Yes), the erroneous stepping risk arithmetic part 27 sets the maximum erroneous stepping risk to be “middle” (step S110). On the other hand, in the step S108, if it is determined that the vehicle speed is less than the entry speed limit (the step S108: No), the erroneous stepping risk arithmetic part 27 sets the maximum erroneous stepping risk to be “low” (step S111).

The erroneous stepping risk arithmetic part 27 then arithmetically operates the erroneous stepping risk, on the basis of the respective outputs of the object type determination part 21, the vehicle speed detector 22, the object distance/speed detector 23, the course predictor 24, and the entry speed limit arithmetic part 26 (step S112). For the arithmetic operation of the erroneous stepping risk, please refer to the explanation of the aforementioned “Configuration”. The driving force limit arithmetic part 28 then determine whether or not the driving force is to be limited and the limit method when the driving force is to be limited, on the basis of the erroneous stepping risk arithmetically operated by the erroneous stepping risk arithmetic part 27, the pedal operation amount detected by the pedal operation amount detector 25, and, for example, the map illustrated in FIG. 3 (step S113).

The driving force limit arithmetic part 28 then arithmetically operates the target value (i.e., a control amount) of the driving force or the braking force, on the basis of the operation amount of the accelerator pedal detected by the pedal operation amount detector 25, the distance and relative speed between the vehicle 1 and the object detected by the object distance/speed detector 23, and a result of the step S113 (step S114). The arithmetically operated target value is outputted to the power train controller 31 or the brake controller 32, by which a required driving force or a driving braking force corresponding to the target value is realized (step S115).

### Technical Effect

In a configuration in which the course of a vehicle is not predicted, it is assumed that the vehicle goes straight. Then, for example, due to an oncoming vehicle on a curve, the operation of the accelerator pedal by the driver may be erroneously recognized as the erroneous stepping on the accelerator pedal, and the driving force is possibly suppressed. Alternatively, for example, near an intersection, even though a driver is about to change a traffic lane from a straight through lane to a right-turn lane, due to another vehicle that drives on the straight through lane, the operation of the accelerator pedal by the driver may be erroneously recognized as the erroneous stepping on the accelerator pedal, and the driving force is possibly suppressed.

On the vehicle control apparatus 100, the object toward which the vehicle 1 goes is specified on the basis of the course of the vehicle 1 predicted by the course predictor 24. Thus, according to the vehicle control apparatus 100, it is possible to prevent that the operation of the accelerator pedal by the driver is erroneously recognized as the erroneous stepping.

Whether the object is an object that has a possibility of collision with the vehicle 1, such as, for example, another vehicle, or an object that does not collide with the vehicle 1, such as, for example, a red light, if the limit method when the driving force is limited (i.e., when it is recognized as the “erroneous stepping on the accelerator pedal”) is uniform or undifferentiated, then, the driver may feel uncomfortable.

On the vehicle control apparatus 100, the maximum erroneous stepping risk is set to be “high” for an object that has a possibility of collision with the vehicle 1, whereas the maximum erroneous stepping risk is set to be “middle” or “low” for an object that does not collide with the vehicle 1. This is because if the object is an object that has a possibility of collision with the vehicle 1, there is a possibility that the vehicle 1 collides with the object due to the erroneous stepping on the accelerator pedal, but if the object is an object that does not collide with the vehicle 1, the vehicle 1 does not collide with the object even when the accelerator pedal is erroneously stepped on.

Thus, even if conditions are the same, such as, for example, the vehicle speed of the vehicle 1, the distance from the vehicle 1 to the object, and the relative speed between the vehicle 1 and the object, except for the type of the object, if the object is an object that does not collide with the vehicle 1, then, the extent of suppression of the driving force when the accelerator pedal is erroneously stepped on can be expected to be moderated in comparison with when the object is an object that has a possibility of collision with the vehicle 1. Thus, according to the vehicle control apparatus 100, it is possible to appropriately deal with the erroneous stepping on the accelerator pedal while preventing the driver from feeling uncomfortable.

Meanwhile, there is known a vehicle with a function that allows a vehicle to be accelerated or decelerated only by the operation of an accelerator pedal, even though a brake pedal needs to be stepped on when the vehicle is to be completely stopped. In such a vehicle, a driver keeps stepping on the accelerator pedal for a relatively long period, so that the possibility of the erroneous stepping on the accelerator pedal is relatively high. If the vehicle control apparatus 100 is mounted on such a vehicle, it can be expected to effectively demonstrate the effect.

Various aspects of embodiments of the present disclosure derived from the embodiment explained above will be explained hereinafter.

A vehicle control apparatus according to an aspect of embodiments of the present disclosure is a vehicle control apparatus provided with: a specifier configured to specify an object toward which a host vehicle goes; an arithmetic operator configured to arithmetically operate an erroneous stepping risk on the basis of a type of the specified object, wherein the erroneous stepping risk indicates an extent of a risk caused by erroneous stepping on an accelerator pedal in which a driver of the host vehicle erroneously steps the accelerator pedal instead of a brake pedal; and a suppressor configured to perform a suppression control of suppressing a driving force of the host vehicle when an operation amount condition associated with an operation amount of the accelerator pedal is satisfied, wherein the operation amount condition is determined in accordance with the erroneous stepping risk, wherein an upper limit of the erroneous stepping risk when the type of the specified object is a type indicating no collision with the host vehicle is set small in comparison with an upper limit of the erroneous stepping risk when the type of the specified object is a type indicating a possibility of collision with the host vehicle, and the suppressor is configured to moderate an extent of suppression of the driving force in the suppression control when the erroneous stepping risk is low, in comparison with when the erroneous stepping risk is high.

In the aforementioned embodiment, the erroneous stepping risk arithmetic part 27 corresponds to an example of the specifier and the arithmetic operator, and the driving force limit arithmetic part 28 corresponds to an example of the suppressor. The “maximum erroneous stepping risk” according to the aforementioned embodiment corresponds to an example of the “upper limit of the erroneous stepping risk”.

The “operation amount condition” is a condition that is determined in accordance with the erroneous stepping risk, in other words, a condition that varies depending on the erroneous stepping risk. On the vehicle control apparatus, the “operation amount condition” is a condition for determining whether or not the driver has erroneously stepped on the accelerator pedal instead of the brake pedal. The “operation amount condition is satisfied” means that an actual operation amount of the accelerator pedal satisfies requirements defined by the operation amount condition. On the vehicle control apparatus, when the operation amount condition is satisfied, it is determined that the driver has erroneously stepped on the accelerator pedal instead of the brake pedal (i.e., it is recognized as the erroneous stepping on the accelerator pedal), and the suppression control is performed by the suppressor.

By the way, whether the object is an object that has a possibility of collision with the host vehicle or an object that does not collide with the host vehicle, if a method of suppressing the host vehicle when it is recognized as the erroneous stepping on the accelerator pedal is uniform or undifferentiated, then, the driver may feel uncomfortable.

On the vehicle control apparatus, the upper limit of the erroneous stepping risk when the type of the object is a type indicating no collision with the host vehicle is set small in comparison with the upper limit of the erroneous stepping risk when the type of the object is a type indicating a possibility of collision with the host vehicle. In addition, on the vehicle control apparatus, the extent of suppression of the driving force in the suppression control is moderated when the erroneous stepping risk is low, in comparison with when the erroneous stepping risk is high.

Thus, even if conditions are the same (e.g., the speed of the host vehicle, the distance between the host vehicle and the object, etc.), except for the type of the object, if the type of the object is a type indicating no collision with the host vehicle, then, the erroneous stepping risk arithmetically operated by the arithmetic operator is expected to be small in comparison with when the object is of a type indicating a possibility of collision with the host vehicle. Therefore, in the suppression control performed when it is recognized as the erroneous stepping on the accelerator pedal (i.e., when the operation amount condition is satisfied), the extent of suppression of the driving force is expected to be moderated when the type of the object is a type indicating no collision with the host vehicle, in comparison with when the object is of a type indicating a possibility of collision with the host vehicle.

In other words, according to the vehicle control apparatus, it is possible to set the suppression control, which is performed when it is recognized as the erroneous stepping on the accelerator pedal, to be different between when the type of the object is a type indicating a possibility of collision with the host vehicle and when the type of the object is a type indicating no collision with the host vehicle. Therefore, according to the vehicle control apparatus, it is possible to appropriately deal with the erroneous stepping on the accelerator pedal while preventing the driver from feeling uncomfortable.

In an aspect of the vehicle control apparatus, the vehicle control apparatus is further provided with a course predictor configured to predict a course of the host vehicle, and the specifier is configured to specify the object on the basis of the predicted course. In the aforementioned embodiment, the course predictor 24 corresponds to an example of the course predictor.

In a configuration in which the course of the host vehicle is not predicted, typically, an object that is ahead of the host vehicle is specified as the object. Then, for example, due to an oncoming vehicle which is specified as the object on a curve, the operation of the accelerator pedal by the driver may be erroneously recognized as the erroneous stepping, even though the host vehicle changes a direction of travel along the curve.

On the vehicle control apparatus, however, the object toward which the host vehicle goes is specified on the basis of the course of the host vehicle predicted by the course predictor. Thus, according to the vehicle control apparatus, it is possible to prevent that the operation of the accelerator pedal by the driver is erroneously recognized as the erroneous stepping.

In another aspect of the vehicle control apparatus, it is harder to satisfy the operation amount condition when the erroneous stepping risk is low, than the operation amount condition when the erroneous stepping risk is high.

When the operation amount condition is satisfied, as described above, it is recognized as the erroneous stepping on the accelerator pedal, and the suppression control is performed. If the operation amount condition when the erroneous stepping risk is low is the same as that when the erroneous stepping risk is high, even though the extent of suppression of the driving force is different between these two cases, the driver may feel troublesome due to implementation of the suppression control.

On the vehicle control apparatus, however, it is harder to satisfy the operation amount condition when the erroneous stepping risk is low, than the operation amount condition when the erroneous stepping risk is high. Thus, when the erroneous stepping risk is low, the implementation of the suppression control is prevented, and it is thus possible to prevent the driver from feeling troublesome. On the other hand, the safety of the driver is ensured by allowing the operation amount condition when the erroneous stepping risk is high, to be easily satisfied, in comparison with the operation amount condition when the erroneous stepping risk is low.

In another aspect of the vehicle control apparatus, the arithmetic operator is configured to arithmetically operate the erroneous stepping risk on the basis of at least one of a speed limit determined in accordance with the type of the object, a space into which the host vehicle can enter in a position of the object, a speed of the host vehicle, and a distance between the host vehicle and the object, in addition to the type of the object. According to this aspect, the erroneous stepping risk can be arithmetically operated, relatively easily.

The present disclosure may be embodied in other specific forms without departing from the spirit or essential characteristics thereof. The present embodiments and examples are therefore to be considered in all respects as illustrative and not restrictive, the scope of the disclosure being indicated by the appended claims rather than by the foregoing description and all changes which come in the meaning and range of equivalency of the claims are therefore intended to be embraced therein.

What is claimed is:

1. A vehicle control apparatus comprising:
a specifier configured to specify an object toward which a host vehicle goes;
an arithmetic operator configured to arithmetically operate an erroneous stepping risk on the basis of a type of the specified object, wherein the erroneous stepping risk indicates an extent of a risk caused by erroneous stepping on an accelerator pedal in which a driver of the host vehicle erroneously steps the accelerator pedal instead of a brake pedal; and
a suppressor configured to perform a suppression control of suppressing a driving force of the host vehicle when an operation amount condition associated with an operation amount of the accelerator pedal is satisfied, wherein the operation amount condition is determined in accordance with the erroneous stepping risk, wherein
an upper limit of the erroneous stepping risk when the type of the specified object is a type indicating no collision with the host vehicle is set small in comparison with an upper limit of the erroneous stepping risk when the type of the specified object is a type indicating a possibility of collision with the host vehicle, and
said suppressor is configured to moderate an extent of suppression of the driving force in the suppression control when the erroneous stepping risk is low, in comparison with when the erroneous stepping risk is high.

2. The vehicle control apparatus according to claim 1, wherein
said vehicle control apparatus further comprises a course predictor configured to predict a course of the host vehicle, and
said specifier is configured to specify the object on the basis of the predicted course.

3. The vehicle control apparatus according to claim 1, wherein it is harder to satisfy the operation amount condition when the erroneous stepping risk is low, than the operation amount condition when the erroneous stepping risk is high.

4. The vehicle control apparatus according to claim 1, wherein said arithmetic operator is configured to arithmetically operate the erroneous stepping risk on the basis of at least one of a speed limit determined in accordance with the type of the object, a space into which the host vehicle can enter in a position of the object, a speed of the host vehicle, and a distance between the host vehicle and the object, in addition to the type of the object.

5. The vehicle control apparatus according to claim 2, wherein it is harder to satisfy the operation amount condition when the erroneous stepping risk is low, than the operation amount condition when the erroneous stepping risk is high.

6. The vehicle control apparatus according to claim 2, wherein said arithmetic operator is configured to arithmetically operate the erroneous stepping risk on the basis of at least one of a speed limit determined in accordance with the type of the object, a space into which the host vehicle can enter in a position of the object, a speed of the host vehicle, and a distance between the host vehicle and the object, in addition to the type of the object.

7. The vehicle control apparatus according to claim 2, wherein said arithmetic operator is configured to arithmetically operate the erroneous stepping risk on the basis of at least one of a speed limit determined in accordance with the type of the object, a space into which the host vehicle can enter in a position of the object, a speed of the host vehicle, and a distance between the host vehicle and the object, in addition to the type of the object.
